(19) United States
(12) Patent Application Publication
(10) Pub. No.: US 2007/0124788 A1
(43) Pub. Date: May 31, 2007

(54) Appliance and method for client-sided synchronization of audio/video content and external data

(76) Inventor: Erland Wittkoter, Hayward, CA (US)

Correspondence Address: Erland Wittkotter;Apt 174, 25200 Carlos Bee Blvd, Hayward, CA, 94542, US

(21) Appl. No.: 11/286,775

(22) Filed: Nov. 25, 2005

(30) Foreign Application Priority Data
Nov. 25, 2005 (DE) 10 2004 057 083.3

(51) Int. Cl. H04N 7/173; H04N 7/16; H04N 7/08

(52) U.S. Cl. 725/112; 725/113; 725/137; 725/138; 725/136

(57) ABSTRACT

The invention pertains to an apparatus and a method for the synchronization of client-sided played video data with server-sided provided additional data, which are displayed or outputted in an additional Content-display or output unit.

### BACKGROUND OF THE INVENTION

The present invention pertains to an apparatus and method for the synchronization of client-sided playing video data with server-side provided additional data as set forth in the classifying portion of Claim 1.

### DESCRIPTION TO THE RELATED ART

With the transmission of video data to a client-sided data processing unit in particular a commercial PC, which by means of a TV tuner card is able to receive TV and/or video, content-related additional data can only be synchronized with web content via a very large effort.

The data processing unit receives video data by means of the reception appliance via a unidirectional broadcast channel by means of a satellite, cable or terrestrial transmission. By the bidirectional Internet connection that is available in the PC further interactive content can specifically be offered for TV programs within the context of the Enhanced TV if they are synchronized with the audio video content. With the changing of the channel by the user the problem arises that the content in the audio/video player is no longer synchronous with the web content.

The player, which is used in state of the art technology, is displaying additional internet data related to the corresponding video, whereby these additional data are included in the data stream and as a result the triggers contained within the data stream are used to be synchronized with the server data. A method that is standardized for the Internet is SMIL (Synchronized Multimedia Integration Language). SMIL is a standard based on XML. It was developed by the World Wide Web Consortium (W3C) as a markup language for time synchronized, multi-media content. SMIL enables the embedding and control of multimedia elements such as audio(s), video(s), text and graphic(s) in web pages; SMIL files can be connected with Java applets and Servlets or CGI scripts and can for example access a database. It is a disadvantage that content must be prepared for SMIL and SMIL is expecting specially adapted runtime software.

Via the insertion of triggers the editor can include requests of external data in the received data stream if he has prepared the content accordingly. These triggers must be inserted separately in a disadvantageous manner for all data formats or types. This is done by means of different technologies.

Triggers are real-time events, which can be used to realize Enhanced-TV. For instance, ATVEF (Advanced Television Enhancement Forum) uses standard triggers. According to this standard, the triggers contain information about extensions that are provided to users by the server. The triggers are used to inform the user or the receiver of the content that corresponding content extensions can be received from a server by means of a local activation signal. Triggers are transmitted via the broadcast medium as digital, textual data. Besides other information, every triggers contain (at least) one standard universal resource locator (URL), which contains the address of enhanced content. The triggers can also contain textual description data or JavaScript fragments, by which JavaScript can be started within an assigned HTML page and/or enhanced content, and can be synchronized with video content.

A disadvantage of this technology consists of that for each new video content, new efforts emerge so that the interactive services have to be adapted by means of changed check and controlling data within these interactive data so that a meaningful interaction with the user can take place.

Furthermore these methods are only offered by an insignificant small portion of the content market or by transmitters. The art of technology also permits data to call content as hyperlinks or URL within video and to display it subsequently in a Web browser.

Disadvantages of this technology consist of the change of the original content and the insertion of additional data. Hypervideos for instance offer users the opportunity via the activation of mouse-sensitive zones on these spatial and temporal limited or restricted areas within the video output to activate a hyperlink and thereby query additional server-sided information. Thereby, data that are extracted on the client-side are sent to the server and the server is sending data, which are assigned to these requests, back to the client. However, the interaction opportunities or options or activation opportunities or capability of a user are inherently restricted within hypervideo by the data, which are contained in the video, that are used for the initiation and usage of an activation signal.

The additional hyperlinks or the server-sided available additional data can only be created or produced by the original publisher or by the web page programmer of this content and not by an independent third party. Furthermore these methods are very costly and the same video content cannot be connected on the server-side with different information or hyperlinks, which address different target groups.

Moreover, the additional adding of metadata or additional data in existing or available content files is very costly and sometimes even impossible, if the file or the video data is not in the direct access by the editor anymore. Since the content cannot be updated subsequently, these restrictions or limitations are dis-advantageous for the usage and/or distribution via the Internet.

A general disadvantage of existing technologies consist of that the content owner or publisher of distributed material or videos doesn't have any direct contact or access and no connection to the content after publication. Furthermore, the user or viewer of the content cannot create a connection from the user or viewer side to the content owner, even if the user or viewer wishes to do this. The close contact between content and the real content owner, indicated by possession, is lost after the publication and therefore also with the possession-related opportunity to make a direct contact with the users or viewers. The creation of a connection, which can contain within it an embodiment, for example the opportunity of communication, can within the known state of the art technology only be recreated with difficulties, in an insufficient and unreliable manner.

Further state of the art technology can be found in the following literature: in the master thesis: “Interaction Design Principles for Interactive Television” by Karyn Y. Lu (Georgia Institute of Technology, May 2005), http://www.broadbandbananas.com/lu.pdf or in “iTV Handbook, Technologies and Standards” by Edward M. Schwalb (IMSC, 2004) or in “Multimedia and Interactive Digital TV: Managing The Opportunities Created by Digital Convergence” by Margherita Pagani (IRM Press, 2003) or in “Interactive TV Technology and Markets” by Hari Om Srivastava (Artech House 2002) or, “The Evolution of TV Viewing” by John Carey (Internet, 2002) http://www.bnet.fordham.edu/careyl/Evol%20of%20TV%2ViewingB.doc or “2000: Interactive Enhanced Television: A Historical and Critical Perspective” by Tracy Swedlow (Internet) http://www.interactive-pioneers.org/itvtoday3.html.

Definition

In the following text, the term “content” is interpreted or understood as: data, file(s) or data-stream(s), and in particular the actual representation of what the data represents or stands for in a suitable, adapted and/or appropriate display or output medium. The content can be the same, whether or not it is represented in different data records or data formats, where its binary output is represented differently.

In the following text, the term “video” is interpreted or understood as: temporal change of pictures or images. The individual pictures (single images or frames) consist of pixel or by means of which pictures or images are generated from data sets. Digital videos consist of data sets which are transformed into motion pictures or images by means of a video visualization unit. The single images or frames within the video are encoded and/or compressed. The decoding method for the representation of the pictures or images is carried out by means of software instructions within software components, which are called codecs.

Complete or entire pictures or images within videos are called frames. Pictures or images, which are represented or displayed within a video, are calculated and/or interpolated by means of differences or interpolations or mathematical methods. In the following text, the term “video frame” is used to represent a “snapshot” or freeze frame or a frame or a calculated and displayable picture or image from a video/audio stream (or its corresponding data stream) or audio/video file.

In the following text, the term “video data” is used to represent audio/video data or data which are transmitted or sent by means of TV or which are played by a video recorder or from a video file.

The backward channel is a data transmission means, which can either be a bidirectional electronic network or a unidirectional connection, in which the client is the transmitter and the server serves as a receiver, and in which the requested data are received by the client via the receiving channel of the client.

Description of the Solution

The present invention pertains to an apparatus and method for the synchronization of client-sided playing video data with server-sided provided additional data as set forth in the classifying portion of Claim 1.

The object of the present invention is to create an appliance for the synchronization of client-sided playing video data with server-sided provided additional data as set forth in the classifying portion of claim 1, in which the additional data are displayed in an additional content visualization/output/representation unit.

The objective is achieved by the apparatus with the features of Claim 1; in particular, all features that are revealed in the present documents shall be regarded in arbitrary combination as relevant and disclosed for the invention; advantageous development of the invention is described in the related, dependent claims.

Web content is transferred or transmitted by means of the electronic network, in particular via Internet, to the PC and is displayed in a web content adaptable content visualization/output/representation unit, in particular a Web browser.

In a manner according to the invention the synchronization of video data is done to clients via a unidirectional transmission and via server-sided stored external data, which are received via an electronic network from a server unit by a client-sided electronic data processing unit by means of a data reception unit, which is designed to receive audio/video data from an unidirectional input channel or communications channel. The bidirectional connection of client and server forms or creates a client server system.

The external data are displayed by a content visualization/output/representation unit, in particular a Web browser. The content visualization/output/representation unit is designed to be an interactive component of the data processing unit so that it can display data and by means of user activatable areas and/or actions can provide interaction with the user. The shown or displayed data are received from the electronic network and/or locally available data are displayed which are loaded in particular from the local cache and/or from the intermediate memory.

The audio/video data are processed and prepared by the audio/video processing unit before they are displayed in the audio/video display or playback unit whereby both units are components of the electronic data processing unit. In addition, the audio/video display or playback unit (35) comprises a channel selection unit, by means of which the audio video content can be displayed or output by other broadcast or transmit channels.

The functional unit, which is assigned to the data processing unit, comprises a receiver or reception and transmission unit, by means of data that are transferred to the server unit connected via the electronic network and/or by which external data can be received. In addition, the invention comprises a control unit used to activate the functional unit by the user which creates and/or extracts marking, labeling, tagging or identification data related to the content that is displayed in the audio/video player and which is by means of the reception and transmission unit transferred to the server in order to receive external data via the electronic network and display subsequently the external data on the client-sided content visualization/output/representation unit.

The functional unit is assigned to the electronic data processing unit or contained therein. The functional unit is able to access the audio visual and/or electronic document. Furthermore it is suitable and adapted to send data via a backward channel, which can be realized in a bidirectional manner, and to receive data via the receiving channel or the backward channel. The functional unit is software or a program which runs on the electronic data processing unit on the program operating environment or system or on the middleware or on the operating system. The functional unit can alternatively be realized as a separate hardware or as a circuit in a CPU or microprocessor. Additionally, this functional unit can be sent by the transmitter via the receiving channel, and it can via the data carrousel or the like, be downloaded or transferred with the audio visual data by means of datacast or the like, and can be executed in the program operating environment or system, or as direct or indirect instructions for the CPU.

The functional unit can be activated at every time by means of an activation signal, particularly if audio/video data are output or represented in the accompanying output device, by means of an assigned activation unit, which is assigned to the data processing apparatus. The activation unit can be a button or an activatable area in the visualization/output/representation unit or a function not visually displayed or denoted which is activated or triggered by a user in a known manner by means of mouse, keyboard or remote control.

The activation of the activation unit is done in a temporal, spatial and/or logical relation or correlation with the viewing of video data or the TV program by a viewer or by the use of video data or the TV program by software instructions that are initiated by a user within the data processing unit used by the user. From the viewpoint of time, the activation refers to a video frame, which is displayed, output or used within the display, output or usage of the video data. The video frame that is used or determined by the activation of the activation unit can be calculated by means of data, parameters or instructions. In particular, those data could be contained in the functional unit or in the metadata as additional data and thereby a video frame or a quantity or amount of video frames, which is different from the displayed video frame, can be selected by means of the activation unit. With the activation of the activation unit, the functional unit uses the extracted data which are part of or assigned to the select video frame or the set of video frames.

Furthermore the functional unit can comprise a content identification unit or metadata extraction unit, by which the marking, labeling, tagging or identification data and/or metadata for the displayed or output audio visual content or a temporal section of the content, such as a scene or a video frame, can be identified and/or extracted and/or generated. Video frame based and/or content-based identifiers or metadata and/or of this content, extracted or generated additional data for the identification of audio-video content, in particular content or scenes or video frame- dependent description data, are called in the following marking, labeling, tagging or identification data. The functional unit can contain the content identification unit or metadata extraction unit or can be separated from it. In the following, the content identification unit or metadata extraction unit is also called the identification data extraction unit.

Furthermore the functional unit can extract or generate data by means of a signature data unit which are in a unique relation to the video frame. The functional unit can contain the signature data unit or it can be separated from the signature data unit. The signature data, which are extracted or generated, or finger-prints are calculated by means of mathematical methods from single video frames or from a set of video frames. The signature data unit can extract data from the video frame-dependent or scenes-dependent signature data, whereby in the following text these are called signature data. The signature data can be assigned to a single video frames and/or to a set of video frames, such as a scene, or to the complete content. The data, from which the signature data can be extracted as metadata, are binary or ASCII based. These data can be extracted by means of a compression method or data transfer method. Furthermore these signature data can be stored within the metadata in an encrypted manner.

The functional unit can be regarded as a combination of technical units or it can be regarded as a technical unit that uses technical means for the coordination between the units and/or that determines, provides or comprises technical or information technology interfaces between the components.

The functional unit or its contained sub functional units don't use triggers, which might be available or assigned within the audio/video content available. In particular, the functional unit does not use triggers, which are used to invite users to activate link data (URLs) that are contained in the triggers.

The activation signal from the activation unit initiates or starts by means of the functional unit in a predetermined manner forming or creating the time index data and/or marking, labeling, tagging or identification data and/or signature data so that by means of the time index data and/or marking, labeling, tagging or identification data and/or signature data related to a video frame created at the moment when the video or TV program is watched while the activation unit has been activated. By means of the mentioned data and or by means of the corresponding data relationships, the mentioned content-dependent data can be determined. The functional unit can contain the activation unit or it can be separated from the activation unit.

Furthermore the functional unit is comprised of an assigned or corresponding transmission unit, which is designed and/or adapted for the transfer, in particular for the separate transfer time index data marking, labeling, tagging or identification data and/or signature data and/or configuration or preference data from the program operating environment or system by means of a backward channel from the client unit to the server unit. The data are transmitted or transferred in a known manner by means of the widely available and standardized communications protocols like TCP-IP, UDP, HTTP, FTP or the like to the server unit, in which the server unit is an application server, file server, database server or Web server, and in which within the server after transmitting in a known manner requesting and/or resourcing, supplying, stocking or provisioning instruction or operations will be triggered. The functional unit can contain the transmission unit or it can be separated from the transmission unit. The data transmission can also happen by means of or within a proprietary transmission protocol such as by means of an order system for Video-on-Demand content.

In the server unit after the reception of the data and the processing and/or analysis of the received data, predetermined and/or assigned server-sided additional data are assigned or calculated, by means of a server-sided assignment, classification or correlation unit provided for the transfer or directly transferred to the client.

The server-sided additional data are preferably content-related or content specific additional data, which refer to the content of the video content. In particular the additional data relate within the content-relatedness to the relationship of the video frame content to the video frame handled or displayed object(s), animal(s) or species of animal(s), plant(s) or species of plant(s), product(s), trademark(s), technology, technologies, transportation means, machine(s), person(s), action(s), connection(s), relationship(s), context(s), situation(s), work(s) of art or piece(s) of artwork, effect(s), cause(s), feature(s), information, formula(s), recipe(s), experience(s), building(s), location(s), region(s), street(s), environment(s), history, histories, results, story, stories, idea(s), opinion(s), value(s), explanation(s), and/or rationale(s), reasoning(s) or the like with corresponding information, which can be comprehend in these categories or included in these categories or themes.

Furthermore in a reception unit or receiver assigned to the functional unit, which are sent from the server to the client or received by the client or received by client-sided, downloaded additional data and processed and or output by the preparation unit for the output, in which the output device and the audio/video data and data visualization/output/representation unit can be identical in an embodiment of the invention and can be separated in another embodiment. The functional unit can contain the reception unit or receiver or it can be separated from the reception unit or receiver.

In another embodiment of the invention the functional unit extracts data by means of a signature data unit which is in a unique relationship and/or assignment to the video frame which was displayed or output during the activation of the activation unit or the functional unit at the video output. These signature data or fingerprint data are calculated by means of mathematical methods, in particular a hash method or a digital signature or a proprietary picture or image transformation method, by means of a single video frame or by means of a predetermined set of video frames. The signature data can be calculated in a manner, so that they are invariant with respect to transformations, as they appear while storing in different picture or image sizes (such as JPEG, GIF, and PNG etc.).

A hash value is a scalar value which is calculated from a more complex data structure like a character string, object, or the like by means of a hash function.

The hash function is a function that generate from an input of a (normally) larger source data or original set or quantity a (generally) smaller target set or quantity (the hash value, which is usually a subset of the natural numbers).

Electronic or digital signature or digital fingerprints are electronic data, which are calculated from digital content. With known fingerprint algorithms such as MD5 or SHA-1 the change of a single bit can lead to the change of the digital fingerprint. With more insensitive fingerprint methods the change of several pixels can lead to the same signature or to the same fingerprint. Preferably within the context of this invention is the usage of an insensitive signature or fingerprint algorithm.

Picture element data are data which are used to define images, for instance pixels or the like, and/or they are data that can be used to identify images, for instance thumbnails of images or digital signature data or digital fingerprint data or the like, and/or they are data that can be used to determine video frames within a context, in particular within video data, as for instance with unique names or identifiers of video data and the serialization of video frames within these video data or to the moment of the appearance of the image as the video data plays and the value of a mathematical hash code of the video image or of the video frame correlated or assigned GUID (Globally Unique Identifier or Global Universal Identifier) or the like.

A hyperlink is a data element that refers to another data element by means of which a user can access data or can get data transferred if he activates or follows the hyperlink. Hyperlinks are realized by URLs, in which an (IP) address of an (in particular external) server and a path or a parameter list is contained, which is applied or executed on the (external) server in order to extract and/or to assign data.

At the use of signature data all audio video data must, to the context specific and/or video content or video scenes specific and/or assigned additional data server-side are made accessible by means of signature data, before the use; all signature data belonging to the video data are shown by a viewer, a server, which is called in the following video index servers.

The initial process of transferring video-content related signature data on the video index server is called in the following as a video or content registration. With the content registration all signature data related to the video data are sent to the video index server and are put down in an index so that the individual signature data can be found faster. With the registration of video data, corresponding additional data, such as title, description of the video data, project number, URL or the like are transferred and/or stored on the video index server. The video index server can either receive the signature data or convert the video data into signature data on the server. After the registration of the signature data, the user or the viewer of the video data can request the additional data by means of the signature data.

The data, which are stored as additional data related to the signature, can consist of a URL, which redirect the user automatically by means of the client-sided or server-sided data processing unit. Additionally, the additional data can be web pages with text, picture(s), image(s), video(s), script(s) (active—in particular exportable code) or interactive element(s), such as menus or text edit boxes or input field or the like.

The signature data, which are created on the functional unit, are searched in the server-sided video index. If the data set is found, the corresponding information can be extracted from the database and can be sent to the client. The video frame that is used for the signature data creation can be the video frame that was displayed or output during activation of the activation unit from the video data or which was displayed or output before or afterwards within a predetermined period of time or that was selected by means of additional metadata or server-sided or broad-cast-sided parameters on the client-side by means of the functional unit. The signature data unit can also extract signature data directly from the description data, in particular within the video frame or from the assigned metadata, whereby the extracted signature data are in a unique relationship or correlation to the video frame, which was selected by the user or it is in relation-ship or correlation to the metadata or description data of the video frame, that is in relationship or correlation to the selected video frame.

The theme or term data are taken from a set of names, terms, concepts, topics, data, addresses, IP addresses, URLs, menu names, category names, to textual ideas of equivalent pictures, images or symbols or the like. In particular, theme or term data can be reduced on the server-side within a transmitter or a program or a video, by means of a time data or a time period data or a combination of the mentioned data, to content-related data of a scene, which a user is watching on a client-sided visualization/output/representation unit at the time or within the period of time of activation of the activation unit. On the server-side, theme data can be selected, filtered, reduced, categorized and/or prioritized by means of choice and/or filter and/or categorization and/or prioritization algorithms.

In another embodiment of the invention the identification value can be inserted by the transmitter into the TV transmitter or into the TV program by means of format or service information within the digital content and/or it can be transferred directly to the server unit or it can be requested by the server and/or it can be assigned to the marking, labeling, tagging or identification data in a client-sided or server-sided manner.

The marking, labeling, tagging or identification data or data that are contained in the content can be used directly for the determination, creation, or extraction of the address of the server unit. Alternatively the functional unit can contain a predetermined address, in particular an IP address or a URL, which is used to transmit data to the server that is determined by the address by means of the assigned transmission unit. In another preferred embodiment of the invention, the first server unit, which receives data of the functional unit, is a server, which provides a list of server addresses. The functional unit receives a server address (URL) from this server, which are assigned in a predetermined manner with data, which have been sent by the functional unit to the server. The functional unit then transmits a predetermined combination of marking, labeling, tagging or identification data, time index data, signature data like server-sided additional data which are received by the first server unit and additional client-sided data which are managed by the local program operating environment or system to the second server such as configuration information or preference data and receives data which are suitable for the client-sided outputting, displaying or representation or further (data) processing, which is transferred for the direct client-sided output or display.

In another embodiment of the invention the server is informed about data which are used by the server in order to provide the transfer of the displayable additional data for the video data, which is watched by the viewer. In particular, the client-sided additional data are used to deliver the user of the output device adapted output data and format and layout data or data which are adapted to the client-sided hardware configuration.

The activation unit can be a manual means for the triggering of a signal that is subsequently, immediately, or with a delay, triggering actions in the functional unit or in the means that is producing or creating signature data, time index data or marking, labeling, tagging or identification data, and which is assigned to the functional unit. The manual means for triggering the signal can be a usual remote control and/or a keyboard and/or a mouse and/or a PDA and/or a Mobil Phone and/or a button directly at the television and/or at the set top box and/or a touch sensitive area on the screen or the like.

The input of the activation signal can happen during the output or displaying of the video data at an arbitrary moment. The input of the activation signal is independent of metadata that might be contained in the video data, of format data or of a predetermined feature or a predetermined processing of the video data.

In a preferable embodiment of the invention, the first server, which receives data of the functional unit, comprises a video index directory, in which video-related signature data are stored and by means of an index are made searchable. In the following, this server is called the video index server. The data that are contained in the video index list or directory created with the same or equivalent methods as the signature data are extracted or generated on the client. The methods are equivalent if the distributed results are the same. The video index server stores signature data or video index data for a video or for a TV program in which these signature data or video index data were produced or created according to a transformation method or to a hash method from the video frame and/or from the corresponding content. Additional information, which is stored with the video index data, contains additional data, in particular address data or IP address information from servers, which contains further displayable information that can be called and can be displayed. The video index server can receive data from the transmission unit, which is assigned to the functional unit, and which is finding content-related data by means of the video index and which provides data to be received by or transmitted to the client.

In another embodiment of the invention the server-sided additional data can consist of address data such as IP address, URL or the like or from not displayable instructions to the functional unit or software component and/or hardware component that are assigned to the function unit by means of which the transferring instruction data or configuration information are executed on the corresponding software component or stored by the hardware unit and/or direct, immediately or timely delays.

Server-sided additional data can comprise or provide user activatable choices, menu bars or activatable options, which are equipped with hyperlink(s) and/or with text, metadata, picture(s), image(s), video(s) or the like. In the simplest version, the user activatable options or choices can consist of a plurality of text data and/or image data and/or hyperlinks.

Server-sided additional data can comprise or provide user activatable choices or the plurality of text data and/or image data and/or hyperlinks and can be displayed in the audio/video and data visualization/output/representation unit and/or in a separate or remote output device.

According to the invention the not finding of specific signature data received from a viewer within the video index can be answered by the server with a standardized set of additional data. These additional data can also consist of a text and picture message. Alternatively, a URL can be sent, which redirects the user to another web page or to another web portal. In another embodiment of the invention the marking, labeling, tagging or identification data, such as the name of the video or the related sequential of (or number within) a video series, result, that the data request is being answered by means of redirecting to a server which is a dedicated web server or web page related to said video. If the time data of the activation, in particular relative to the beginning of the video, can be extracted and/or can be determined on the server-side, then also scene-dependent additional data can be extracted and corresponding data prepared on the server for the download or for the supplying, provisioning or stocking.

According to another preferred embodiment of the invention, the digital signatures or the signature data can be hash codes which are formed by or created from the electronic content file directly or after a filter or a data converter has been applied.

The digital signature can dependently or independently from the data format make use of the grey or color values distribution of the pictures or images in order to distinguish data or files from each other uniquely; in addition, the digital signature data can also be used to recognize or identify similar pictures or images automatically or to calculate distances between images by means of the digital signature data and by means of an order relationship to find similar images via database access efficiently. In this digital signature file format value can also be contained such as image sizes or compression method in order to gain a quick unique distinction between different data or files.

Preferably, the digital signature can be created in a manner that the corresponding signature data of content data, which have been stored after conversion in diverse or different output formats, and which have been derived from a common source, shows a very high conformity via signature data, such that even content files with diverse or different formats can automatically and mutually be identified via signature data.

The electronic signature data is used in the server-sided signa-ture-data-to-additional-data relationship unit to select and/or to determine and/or to calculate additional data, which are stored and assigned via relationship therein. The additional data, which are associated with a particular digital signature, are sent from the server to the function unit where they are displayed in or via the document-visualization/output/representation unit. The additional data can also consist of addresses, IP or URLs and the client-sided functional unit can be used for another server-side data request, so that the data are provided for the client-sided output by these other (further) servers.

The content, for which the content signature data are formed or created, are invariant with respect to the server-sided additional data. The server-side, in particular content-related additional data, does not change the content that is related to the signature data and they are also invariant with respect to data transformations or changes in the used video format or video codec. The additional data are preferably adapted to be output in the client-sided visualization/output/representation unit or as a hyperlink to provide a link with further resources.

In another embodiment of the invention registered signature data of a predetermined codec or format of video content that is transformed into video content of another content codec such that corresponding signature data can be inserted as alternative values of the original signature values.

The server-sided additional data can preferably be represented or displayed by the visualization/output/representation unit, which is assigned to the client-sided functional unit or in an independent window or screen or it is reprocessed or further executed by the functional unit or an assigned software or hardware component as a data set.

The server-side additional data are preferably data in which user activatable options or choices are provided. These options or choices, which are activatable by users, consist of a plurality of displayable text data and/or image data and/or multimedia data and hyperlinks. In another embodiment of the invention, these hyperlinks are activated manually by the user, whereby the client-sided activation data, which is as a data set or as a plurality of data sets, are transferred to the server unit, and in which these server units other predetermined server units are transferring further additional data to the client. The data, which are transmitted by the client-sided functional unit to the server, like in another preferred embodiment, the content signature data are contained, which are stored on the server, together with the client-sided selected data, such as category or topic names, theme names, in the signature additional data relationship unit.

In another embodiment of the invention, movies or videos can be divided or separated into scenes, whereby a scene consists of a connected set of single images or video frames and scenes can be assigned to a plurality of content-related additional data. In another embodiment of the invention the functional unit is designed in a manner, activated by a control unit, in which it receives external data from a server and causes a client-sided output of the external data in the content visualization/output/representation unit so that a data within the external data causes a change of the displayed receiving channel within the display, output or playback unit.

### SHORT DESCRIPTION OF THE DRAWINGS

Further advantages, features and details of the invention will be apparent from the following descriptions of preferred embodiments and with references to the following drawings:

FIG. 1: a schematic image for the synchronization of client-sided output audio/video data with corresponding server-sided stored external data

FIG. 2: a schematic block diagram for the methods of synchronization of client-sided output audio/video data with corresponding server-sided stored external data

### DETAILED DESCRIPTION OF THE INVENTION

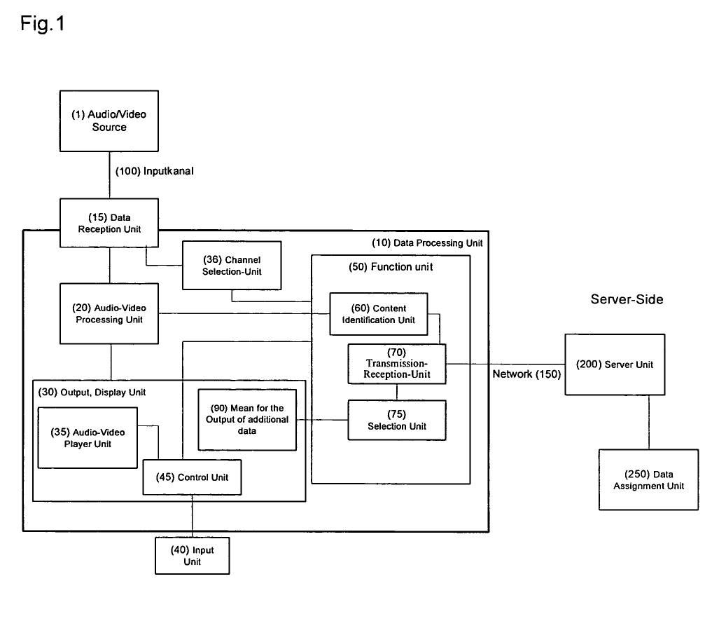

FIG. 1 describes a schematic image for the synchronization of client-sided output audio/video data with corresponding server-sided stored external data in a client server system that is connected by means of a receiving channel (100) and a backward channel (20) which comprises the client-sided electronic data processing unit (10) and on server-side, the server appliance (200).

A video source (1) transmits audio/video data (25) over an input channel (100), which is in a specific embodiment, the Internet, to a client-sided data reception unit or receiver (15), which converts the received data so that the data are adapted to the output in the visualization/output/representation unit (20) and/or can be output in the visualization/output/representation unit or output device. The displayed audio/video data consist of single pictures or video frames. The visualization/output/representation unit (20) is a media player on a commercial or conventional PC.

By means of an input unit, for instance a mouse, keyboard or remote control (40) a user can trigger an activation signal (46) in an activation unit (45). The activation unit can be, in a simple embodiment, a button of the remote control of a set top box (STB) or mouse-activatable areas provided in the visual user interface of a PC. The data input is connected with the input unit (40) outside the data processing unit (10).

The activation signal is being sent by the functional unit (50) defined by the program sequence of runtime or operation system to the content identification unit (60) and/or to the in (60)-contained signature data unit, in order to enable and/or trigger access to the audio/video data, in particular on the binary video content and on the metadata and/or service information and/or format information that is assigned to the content.

The content identification unit (60) extracts textual data contained in the video content, which are contained in digital form as a broadcast tag or label and/or as a program tag, label or mark. These data are included in digital television (DVB) within the service data or format data. A program operating environment or system, as it is contained in a STB by means of middleware, is able to isolate these values by means of a data extraction in a predetermined manner.

The content identification unit can also be designed as a signature data unit which extracts a video frame from the audio/video data.

The extracted video frame can be the image that was displayed or created by the video data displaying or outputting unit (15) at the time in which the activation signal was created by a user. By means of the signature data unit (62) the fingerprint algorithm is executing the data processing of the extracted video. First within the color normalization or standardization the color scheme error found is corrected by means of a color histogram technique which reduces the color scheme errors in a predetermined manner. A subsequent grayscale calculation or computation for all pixels leads to a grayscale image. Subsequently, via averaging (mathematical average value creation) over all pixels, in which pixels are assigned to one pixel after reduction in the size of the thumbnail, the thumbnail will be calculated. The thumbnail has a size of 16*16, whereby this is reduced linearly from the original picture to the thumbnail. The limits or borders of the area, over which pixel values are averaged, arise from equidistant width and heights. Considering the 16*16 size of the thumbnail, the pixel width of the picture and the pixel height of the picture must therefore be divided by 16. The fractions of a pixel between adjacent areas have to be considered in the averaging as a fraction accordingly.

Alternatively, the fingerprint can be delivered within the content as enclosed corresponding textual additional data, and by means of a corresponding identification, the signature unit (62) can extract these signature data or fingerprints from the additional data that are contained in the content. Since the signature data are not enclosed in every video frame, in general, the unit (62) does not extract the corresponding fingerprint related to the video frame, which has been displayed at the moment of activation of the activation unit. Instead, the signature data could be used which were contained in the data and/or are or were already or will be delivered. The exact time data related to the activation can be determined by the signature data creation unit via the timer that is contained in the processor and via measuring the time period between activation and appearance of the corresponding data and by sending this difference with the finger-print or signature data to the server.

On the server side (200), the received data are assigned to content-related additional data by means of a database. This assignment can, by means of the data that are contained in time index and marking, labeling, tagging or identification data, can contain data on the server-side, via data that are stored in the database and that are used to describe the video or TV program, being assigned to this video or TV program. Alternatively by means of time index and marking, labeling, tagging or identification data the assignment can also be referred to a scene, such as to video frames on the server-side. Alternatively by means of the signature data a video frame that is assigned to a signature can be found. In each of these cases, the transmitted data can be associated or assigned with video data or with scenes data. Since the data assignment or relationship unit (250) enables an assignment from scenes to term data and from term data to link data or to additional data, the server unit (200) can provide video content-related additional data as a response to its data reception.

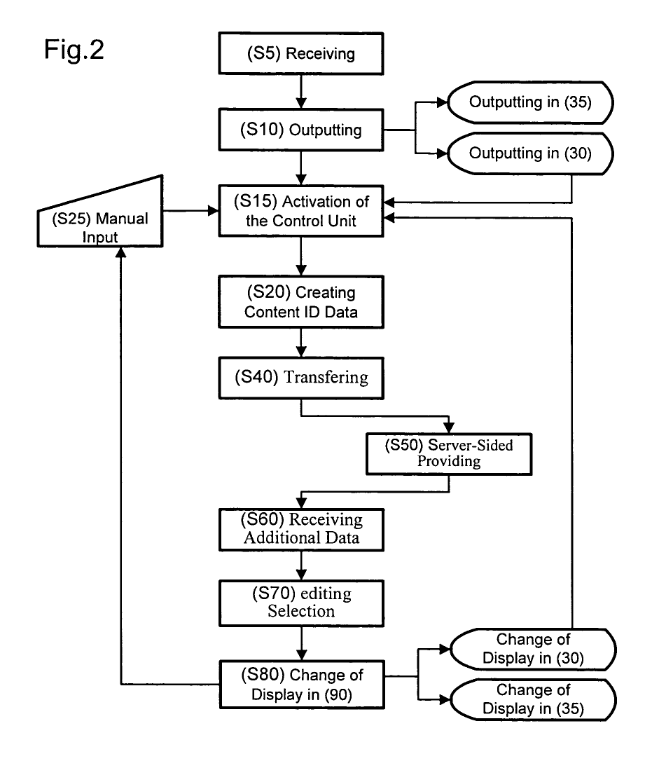

These content-related additional data are then transferred by means of the Internet-capable network (150). FIG. 2 describes a method for the synchronization of client-sided output audio/video data with corresponding server-sided external data.

The received data are displayed by a client-sided data preparation unit for the client-sided output in the output device (90).

### Further Advantages and Embodiments

According to the invention videos such as films, documentations, interviews, reports, TV shows as well as commercials, which are distributed via a transmitter or via another distribution mechanism (Internet, DVD), can also comprise these additional data. A viewer or user can extract a video frame from the video or from the corresponding data stream by means of an extraction unit, in particular by means of a program or by means of a plug-in within the video display or player unit (media player) that sends data by means of offered transmission means (such as a data interfaces contained within the program) to the corresponding server and subsequently receives detailed information or content-related additional data related to the content of the picture and/or to the content of the scenes. Thereby, in accordance with the invention, a more extended integration of the broadcast based television in the Internet, in particular into the Peer-to-Peer based and/or client-server based Internet, will be possibly without, in an advantageous manner, further costly technical measures that would be necessary for the transmitter infrastructure of the TV broad-caster.

In a manner, according to the invention, registered content, which is content that has been provided by the owner or by the transmitter to the server, according to the invention, can, by means of registration, previously announced content, be provided with scene-dependent additional data or with link data.

Particularly advantageous is the device, according to the invention, for the assignment of product related advertising to the watched TV content, without interrupting as done with the current inserted advertising. Instead the user is, as in the Internet, in control, of what he wants to see. The advertising that is activated by him is more relevant in contrast with inserted television advertising, which is pushed to the viewer without a direct reference to him. The link data offered to the user, according to the invention, enables the user to watch only the advertising or content that is chosen by him.

Therefore, the device, according to the invention, provides the same advantages as the Internet: control, choice, convenience and speed.

The device, according to the invention, enables the data exchange of signature data between viewers so that instead of verbally reporting the seen TV show, the signature data can be sent to a second person and this person can use the signature data by means of its functional unit, and the second person gets the same additional data. In particular, the second person can be enabled by means of link data, to watch the corresponding video which provides additional income and proceeds for the owner of the content or transmitter by means of Content- or Video-on-Demand. The device, according to the invention, enables the server-sided assignment of additional information (terms, concepts, link data, web pages) and metadata to continuous stream or videos which are published as video data, whereby the additional data and/or metadata are influencing in a content-related and context-describing manner on the continuous or uninterrupted contents of a scene (which extends on several ongoing video frames). The scenes are set on the server-side in a direct relation to the textual description of the content by means of corresponding data.

The Internet provides users or viewers of a video by means of the invention the opportunity to extract, select and to display context related, in particular relevant, metadata in relationship to the video. In particular, by means of utilizing hyperlinks in the output the viewer or user has the opportunity to make use of a large number of relevant information.

The use of the server-sided data by a client or a client-sided user or viewer can be reached efficiently by means of standardized interfaces, in particular by means of XML and XML over HTTP (SOAP—Simple Object Access Protocol).

The outputting or displaying of terms can be done by means of a menu, in which more detailed option can be created by means of pull-up, drop-down or explorer (list like or directory like) organization of information. A menu element can either be a link data element to further information or it can be a list or directory in which either further link data or additional menu options are offered. Alternatively also multimedia text (text with pictures, videos, animations or interactions) can be output, displayed or distributed after the activation of menu options. In this manner link data element can be output or displayed or the link data element can immediately be output or displayed in data, which can be called by means of link data.

The additional data which are delivered by the server, according to the Invention, can be used in the client-sided document visualization/output/representation unit, so that the corresponding content, for instance a scene or a temporal interval, which is in a predetermined timely distance to the requested element will not be output, so that for example within a parental control system, questionable content could be suppressed or skipped in the client-sided output by means of server-sided additional data. These methods comprise the advantage that parental control data does not have to provide this information to the display or player unit only at the beginning of the file or data stream. The display or player unit can start at any time within the video to play the content, and it can request corresponding data on the server side, in particular if the corresponding data doesn't exist in the video on the client-side any longer or was removed. Category names or terms can contain in the term table directly one list or set of server addresses with corresponding parameters (for example URLs) whereby these addresses or URLs can comprise additional text, description(s), picture(s), video(s) or executable script(s).

Terms can be taken from a catalog unit. These terms or category names are invariant terms or concepts. Equivalent translations into other languages can be assigned to these category names and be inserted in the corresponding catalog unit as a translation for a term. A multilingual term-based reference system can be created in which to every used term a video scene can be shown. Additionally, creators or editors can extend the catalog of sub-category names and/or of further term relationships between category names within the framework of Open Directory Initiatives.

In another concrete embodiment of the invention, the additional data are visual, acoustic or multi-media data or they are description data or predetermined utilization operations, such as hyperlinks which refer to predetermined server-sided document server units or product databases, which are activated and/or questioned by a user or the additional data are data which are assigned directly to the mentioned data.

In another embodiment, the utilization operations can also be predetermined dynamic script instructions which output data on the client-side and/or display or output these server-sided received data. From the server-side databases or server, further content related terms or additional data, can be requested by means of the digital content signature data or by means of terms or additional data, which are assigned to the signature data. These additional data can subsequently and on the client-side be output or displayed or stored and/or reprocessed by the client-sided data processing unit.

By means of additional data related to the landscape videos of landscapes or vacation spots can be found over the Internet. The assigned videos or video scenes can display hotels or ruins or other vacation destinations. Another advantage of the present invention is based on the circumstances that created by the producer, additional data don't make web pages excessive or unnecessary, but facilitate the surfing between similar web pages for the viewer or the user. Furthermore the invention enables a user of a video to receive content-related web pages and new visitors or viewers would come, by means of server-sided additional data, increased value, to these web pages.

By means of additional data or terms, video data or video scenes can comprise a territorial assignment, such that, for instance, the recording or shooting of videos or of a scene can be found with additional location based data.

In the same manner, pictures, images or videos of objects (works of art) can be found by means of standardized category terms or terminology. In the same manner, training or educational movies, or computer simulations can be supplied and found with keywords.

The additional data can represent structured descriptions of landscapes or certain objects like buildings or acting persons. These data can be provided to a search engine. This gives someone the opportunity to find the content via the external scene descriptions for movies or videos without knowing that this was specifically intended as such by the Publisher.

The metadata or additional data for the video content can contain historical background information or its meaning, thereby providing the interested user or viewer additional information delivery.

The same benefit arises from the subsequent attachment of information to works of art, paintings, movies, architectural buildings or structures, animals, plants, technical objects such as machines, engines, bridges or scientific pictures, images, videos, files, programs or simulations from medicine, astronomy, biology or the like. Also, shown trademark logos within videos can be represented or can be made searchable in the database, according ing to the invention, by means of the corresponding additional data. As a result, a trademark owner can get information about the distribution of his logos and to the context of usage of the logos.

Furthermore, concrete objects or items such as pictures, images of consumable products or investment goods can very precisely be described with additional data as well, and can be represented in the database according to the invention.

The preferred Fingerprint method has the attribute, feature or quality such that the result of the application of the finger-print methods is insensitive with respect to small changes in the picture elements, in particular pixels. This is achieved by the usage of averaging instructions on grey levels in the pixels that are contained in the corresponding areas of the picture. Preferably a method is used that transforms every picture into a standard size—for example 8*8 pixels or 12*12 or 16*16, which is called in the following thumbnail, and which comprises, for every pixel of the thumbnail, a corresponding color or grey levels depth such as 8 bits, 12 bits or 16 bits for every pixel contained in the thumbnail. In the transformation of the original picture onto the thumbnail, each pixel of the thumbnail corresponds to an area of the original image. By the use of mathematical methods the color error can be reduced (and its impact can be made insignificant). After the transformation into grey levels, an average grey level value can be calculated from this area by averaging over all corresponding (relevant) pixels. In addition, rules can guarantee that pixel on the border or edges are taken only into account with the corresponding fraction of their value. With this averaging, the influence of some or a few pixels is negligible. As soon as the methods for the creation of these fingerprints are standardized, these fingerprint data can also be created or produced on the client-side and be searched in the database. Possible methods to find and search fingerprints within a database consist in the repeated application of averaging (of grey values) over areas within the fingerprints in order to get data of a length, which is indexable in the database. The indexing method is variable and can be adapted by means of optimization to the size of the database.

Another advantage and application of the present invention consists of the automated transfer of server-sided additional data to the client, in particular if the activation unit creates or produces an activation signal in a time-controlled and/or periodical and/or in an algorithmically-controlled manner and the client-sided reception unit or receivers receive the extracted data and the client-sided output device displays or outputs content-related updated additional data, which are updated in and to the video content. In an embodiment of the invention script instructions or program software instructions that are contained in the additional data, which are delivered by the server, can be used to activate the activation unit in order to update the client-sided displayed or output content.

Table of References

The following table contains additional descriptions of the references to FIGS. 1 and 2, and it is part of present invention and its disclosure.

Reference descriptions are:

| | |
|---|---|
| (1) | Means for the sending, transmitting or broadcasting of |
| | data or source of data in particular audio/video data |
| (10) | Electronic data processing unit or appliance |
| (15) | Data-reception unit or means for the reception of data |
| | from the input channel(s) (100) |
| (20) | Audio/video processing unit or means for the processing |
| | or usage of audio/video data |
| (25) | Audio/video data or data and means for the management, |
| | administration and providing, provisioning or supplying |
| | of audio, video data by means of data, whereby these data |
| | can also consist of control- and steering or regulation |
| | data and/or data, which consist of a plurality of single |
| | video frame(s) which are assigned to the audio/video data |
| | (25) |
| (26) | Single video frame from the plurality of video frame(s) |
| | that forms a audio/video file |
| (30) | Content visualization, output or representation unit or |
| | means for the integrated visualization, output or repre- |
| | sentation of data in different formats and types in a |
| | common output window or output unit |
| (35) | Audio-video display or playback unit or means of visu- |
| | alization or representation and output of audio-video |
| | data in a visualization, output or representation unit by |
| | means of remote or external control- and visualization or |
| | output instruction |
| (40) | Input unit or means for inputting of data, commands or |
| | instruction via a user |
| (45) | Control or activation unit or means for the control or |
| | activation of the function unit (50) and/or the au- |
| | dio/video display or playback unit in particular by means |
| | of the manual activation or action of a user by means of |
| | an input unit (40) |
| (46) | Signal(s), or data that are created or generated by the |
| | control unit (45 and is received by the function unit |
| | (50) |
| (46′) | Signal, or data, which are generated or created by the |
| | control unit (45) and/or visualization, output or repre- |
| | sentation unit (30) and/or audio-video display or play- |
| | back unit (35) |
| (50) | Function unit or means for the access to data in the au- |
| | dio-video processing unit (20), calculation, creation or |
| | extraction of data from the audio-visual content (25), |
| | transmission or broadcasting and reception of data to or |
| | at the server unit (200) and output of the received data |
| (60) | Content identification unit or means for the unambiguous |
| | marking, labeling, tagging or identification of audio |
| | visual data by means of extracting or generating or cre- |
| | ating of marking, labeling, tagging or identification |
| | data (65) and single video frame(s) of marking, label- |
| | ing, tagging or identification data (66) |
| (65) | Marking, labeling, tagging or identification data or |
| | data or data records for the unambiguous description |
| | and/or characterization of audio/video data (25) |
| (66) | Video frame dependent marking, labeling, tagging or |
| | identification data or data or data records for the de- |
| | scription and/or characterization of single video |
| | frame(s) |
| (70) | Transmission- and input or reception unit or means for |
| | the transmission or broadcasting and/or for the reception |
| | of data to and/or of a server unit (200) |
| (75) | Selection unit or means for the selection and creation of |
| | a set of additional data from the received set of server- |
| | sided additional data |
| (90) | Output unit for additional data or means for the output |
| | or visualization of additional data in a visualization, |
| | output or representation unit |
| (100) | Reception- or input channel, means and/or medium that is |
| | sending, broadcasting and/or receiving audio/video data |
| | (25) in and/or via a sender or transmitter (1) and/or au- |
| | dio/video source |
| (150) | Electronic network or means for the transmission or |
| | broadcasting of data between a client and a server |
| (200) | Server unit or server device or appliance |
| (250) | Data assignment unit or means for the providing, provi- |
| | sioning or supplying of additional data and/or means for |
| | the assigning of time index value(s) and/or marking, la- |
| | beling, tagging or identification data (65) to addi- |
| | tional data |
| (S5) | Process step for the reception of audio/video data (25) |
| | via a sender channel (100) in a data reception unit (15) |
| (S10) | Process step for the displaying or outputting of au- |
| | dio/video data (25) in the data visualization, output or |
| | representation unit (30) |
| (S15) | Process step for the activation of the function unit (50) |
| | by means of signal(s) (46), that are received from a con- |
| | trol unit (45) |
| (S20) | Process step for the creating or generating of a content |
| | ID for the identification of content, of the transmission |
| | or broadcasting channel and/or of the program |
| (S25) | Process step for the manual input or activation of a con- |
| | trol signal |
| (S40) | Process step for the transmission or broadcasting of |
| | marking, labeling, tagging or identification data |
| | (65) and/or video frames dependent marking, labeling, |
| | tagging or identification data (66), by means of the |
| | transmission or broadcasting- and reception unit (70) and |
| | of the electronic network (150) to the server unit (200) |
| (S50) | Process step for the providing, provisioning or supplying |
| | of server-sided additional data by means of server-sided |
| | assignment unit (250) |
| (S60) | Process step for the reception of the server-sided addi- |
| | tional data by means of the transmission- and input or |
| | reception unit (70), |
| (S70) | Process step for the selection of the received additional |
| | data and creation of a displaying and outputting set of |
| | additional data by means of the selection unit (75) |
| (S80) | Process step for the client-sided displaying of the addi- |
| | tional data in a mean for the output of additional data |
| | (90) in a content visualization, output or representation |
| | unit (90) |

1. Apparatus for the synchronization of playing video data with server-sided provided additional data to by means of a reception channel received video data, in a by means of an electronic network (150) connected client server system, with
a client-sided electronic data processing unit (10), which is by means of a channel selection unit suitable to output video data on a video player unit (35),
a content output unit (30), in particular a web browser, which is an interactive components of the electronic data processing unit (10) that is suitable for the outputting or displaying and processing of data that are received via the electronic network
characterized by
a content identification unit (60) that comprise means for the extraction and generation of a marking, labeling, tagging or identification data and/or a signature data related to video data and
as reaction on a control signal of a control unit activates the content identification unit and extracts and/or generates the marking, labeling, tagging or identification data and/or signature data and transmits via means for the transmission or delivering and for the reception (70) to a server and
server-sided for the marking, labeling, tagging or identification data and/or signature data corresponding content-related additional data are provided and
client-sided received and the additional data are outputted or displayed in the content display or output unit (30).

2. Apparatus as set forth in claim 1, characterized in that the channel selection unit is a means for the changing of video data from the data reception unit.

3. Apparatus as set forth in claim 1, characterized in that the control unit receives the control signal from the content display unit.

4. Apparatus as set forth in claim 1, characterized in that the content identification unit extracts content identifier data from the video related additional data that is contained in the video data.

5. Apparatus as set forth in claim 1, characterized in that the content identification unit extracts or creates a channel recognition data and a time index data and/or a content dependent fingerprint data.

6. Apparatus as set forth in claim 1, characterized in that the content identification unit extract data from the content and/or from the corresponding VBI data in particular teletext data and/or extracts and/or generates from the corresponding service- and/or format information.
